(19) United States
(12) Patent Application Publication
(10) Pub. No.: US 2026/0094241 A1
(43) Pub. Date: Apr. 2, 2026

(54) HIGH DYNAMIC RANGE (HDR) IMAGE TRANSFER

(71) Applicant: QUALCOMM Incorporated, San Diego, CA (US)

(72) Inventor: Petter Oestlund, Lund (SE)

(21) Appl. No.: 18/903,529

(22) Filed: Oct. 1, 2024

(51) Int. Cl. G06T 5/50

(52) U.S. Cl. CPC G06T 5/50; G06T 2207/20208

(57) ABSTRACT

A method of operation of a processing system includes receiving, from an image sensor, image data in accordance with a high dynamic range (HDR) image capture operation. The method further includes receiving, for at least one pixel value of the image data, an indication that the pixel value corresponds to a particular exposure of a plurality of exposures captured by the image sensor in accordance with the HDR image capture operation. The method further includes performing one or more operations in accordance with the image data and the indication and outputting one or more image frames in accordance with the one or more operations.

### TECHNICAL FIELD

Aspects of the present disclosure relate generally to image processing, and more particularly, image processing involving one or more high dynamic range (HDR) images.

### DESCRIPTION OF THE RELATED TECHNOLOGY

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

Dynamic range may be important to image quality when capturing a representation of a scene with a wide color gamut using an image capture device. Some image sensors may have a limited dynamic range, which may be smaller than the dynamic range of human eyes. Dynamic range may refer to the light range between bright portions of an image and dark portions of an image. Some image sensors may increase an exposure time to improve detail in dark portions of an image at the expense of saturating bright portions of an image. Alternatively, some image sensors may decrease an exposure time to improve detail in bright portions of an image at the expense of losing detail in dark portions of the image. Thus, some image capture techniques may attempt to preserve detail in either bright portions or dark portions of an image by adjusting exposure time. High dynamic range (HDR) image processing techniques may improve image quality by combining multiple recorded representations of a scene from the image sensor.

Although HDR image processing techniques may improve image quality in some cases, such techniques may be costly, may reduce device performance in some circumstances, or both. For example, components such as a buffer or a bus may need to have sufficient storage capacity or bandwidth to accommodate multiple recorded representations from an image sensor. Some techniques may involve compressing the recorded representations to reduce data size, which may result in data loss in some scenarios. Further, processing resources may be used to merge or compress the multiple recorded representations.

### SUMMARY

The systems, methods and devices of this disclosure each have several innovative aspects, no single one of which is solely responsible for the desirable attributes disclosed herein.

In some examples, a method of operation of a processing system includes receiving, from an image sensor, image data in accordance with a high dynamic range (HDR) image capture operation. The method further includes receiving, for at least one pixel value of the image data, an indication that the pixel value corresponds to a particular exposure of a plurality of exposures captured by the image sensor in accordance with the HDR image capture operation. The method further includes performing one or more operations in accordance with the image data and the indication and outputting one or more image frames in accordance with the one or more operations.

In some additional examples, an apparatus includes a processing system including one or more processors and one or more memories coupled to the one or more processors. The processing system is configured to receive, from an image sensor, image data in accordance with an HDR image capture operation and to receive, for at least one pixel value of the image data, an indication that the pixel value corresponds to a particular exposure of a plurality of exposures captured by the image sensor in accordance with the HDR image capture operation. The processing system is further configured to perform one or more operations in accordance with the image data and the indication and to output one or more image frames in accordance with the one or more operations.

In some further examples, a non-transitory computer-readable medium stores instructions executable by a processing system to initiate, perform, or control operations. The operations include receiving, from an image sensor, image data in accordance with an HDR image capture operation and receiving, for at least one pixel value of the image data, an indication that the pixel value corresponds to a particular exposure of a plurality of exposures captured by the image sensor in accordance with the HDR image capture operation. The operations further include performing one or more operations in accordance with the image data and the indication and outputting one or more image frames in accordance with the one or more operations.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffers, processor(s), interleavers, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a block diagram illustrating an example of a system that supports high dynamic range (HDR) image transfer.

FIG. 2 is a block diagram illustrating an example of a system that supports HDR image transfer.

FIG. 3 is a diagram illustrating examples of graphs that may be associated with HDR image transfer.

FIG. 4 is a flow chart illustrating an example of a method that supports HDR image transfer.

Like reference numbers and designations in the various drawings indicate like elements.

### DETAILED DESCRIPTION

In some aspects of the disclosure, a camera device may capture multiple exposures in connection with a high dynamic range (HDR) image capture operation. The camera device may select pixel values of an image from among the multiple exposures. For example, if the image includes pixels 0, 1, . . . N (where N indicates an integer greater than one), then the camera device may compare the 0th pixels from the multiple exposures and may select one of the 0th pixels for the image, may compare the 1st pixels from the multiple exposures and may select one of the 1st pixels for the image, and may compare the Nth pixels from the multiple exposures and may select one of the Nth pixels for the image, and so on. In some examples, pixels may be selected based on one or more criteria, such as, for example, signal-to-noise ratio (SNR) and saturation level.

The camera device may provide the image to another device over a bus or other connection. The camera device may also provide an indication (e.g., a set of index values, such as a mapping table) indicating, for each pixel value of the image, a corresponding exposure of the multiple exposures that is associated the pixel value. To illustrate, the indication may specify, for each pixel value of the image, whether the pixel value was selected from one exposure from the multiple exposures or from another exposure of the multiple exposures.

One or more features described herein may improve performance of a device that captures images or that receives captured images. For example, by selecting pixel values from among different exposures “in camera” and prior to sending image data to the device, an amount of data transferred over a bus between the camera and the device may be reduced as compared to other techniques, such as techniques that involve transferring all exposures of the bus. As a non-limiting example, in some implementations, a pixel value may include (or may be represented by) eight bits, and an HDR image capture operation may include capturing four exposures. In such examples, some techniques may involve transferring thirty-two bits for each pixel of image data (8*4=32). In some aspects of the disclosure, a pixel value may be selected from a particular exposure of the four exposures, and two bits may be used to indicate the particular exposure, resulting in a transfer of ten bits (8+2=10) for each pixel. Accordingly, a quantity of bits transferred over a bus or other connection may be reduced, reducing a traffic load associated with the bus or other connection. Further, the traffic load may be reduced without use of a compression scheme that may introduce data loss. Accordingly, traffic load may be reduced while increasing (or maintaining) data quality.

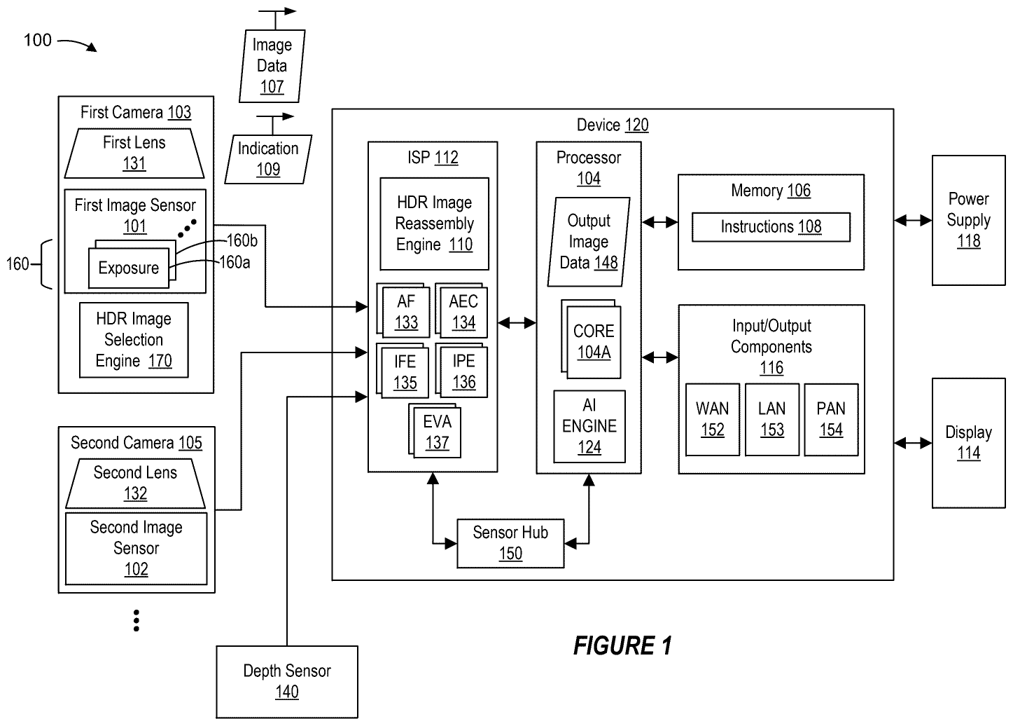

FIG. 1 is a block diagram illustrating an example of a system 100 that supports HDR image transfer. The system 100 may include a device 120. In some examples, the device 120 may include or may correspond to an integrated circuit, such as a system-on-chip (SoC) device. In some examples, the device 120 may include an image signal processor (ISP) 112 for processing image data from one or more image sensors, such as a first image sensor 101, a second image sensor 102, and a depth sensor 140. In some implementations, the device 120 may include or may be coupled to a processor 104 and a memory 106 storing instructions 108 (e.g., a memory storing processor-readable code or a non-transitory computer-readable medium storing instructions). The device 120 may also include or be coupled to a display 114 and components 116. Components 116 may be used for interacting with a user. For example components 116 may include a touch screen interface, one or more physical buttons, or a combination thereof.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The system 100 may further include a power supply 118 for the system 100, such as a battery or an adaptor to couple the system 100 to an energy source. The system 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the system 100. In some embodiments, AFEs may be embedded in the ISP 112.

The system 100 may include or be coupled to a sensor hub 150 for interfacing with sensors to receive data regarding movement of the system 100, data regarding an environment around the system 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the system 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the system 100, including the ISP 112 and/or the processor 104.

The device 120 may receive captured image data. In one example, a local bus connection couples the ISP 112 to the first image sensor 101 and second image sensor 102 of a first camera 103 and second camera 105, respectively. To illustrate, the local bus connection may include or may correspond to a serial interface, such as a camera serial interface (CSI), a Mobile Industry Processor Interface (MIPI), one or more other interfaces, or a combination thereof. In another example, a wireless interface may couple the device 120 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the system 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different fields of view (FOVs) to capture different representations of a scene. For example, the first lens 131 may be an ultra-wide (UW) lens and the second lens 132 may be a wide (W) lens. The multiple image sensors may include a combination of UW, W, tele (T), and ultra-tele (UT) sensors.

Each of the first camera 103 and second camera 105 may be configured through hardware configuration and/or software settings to obtain different, but overlapping, FOVs. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A VA camera may have different characteristics that produced different representations of a scene based on a current aperture size. For example, a VA camera may capture image data with a depth of focus (DOF) corresponding to a current aperture size set for the VA camera.

The ISP 112 processes image data captured by the first camera 103 and second camera 105. While FIG. 1 illustrates the system 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the system 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include hardware (such as one or more integrated circuits (ICs)) configured to perform one or more operations described in the present disclosure. To illustrate, the ISP 112 may include an HDR image reassembly engine 110 that may initiate, perform, or control one or more operations described herein. Depending on the implementation, the HDR image reassembly engine 110 may be implemented using instructions executable by the ISP 112, hardware, or a combination thereof.

FIG. 1 also illustrates that the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described herein. The instructions 108 may include a camera application (or other suitable application such as a messaging application) to be executed by the system 100 for photography or videography. The instructions 108 may also include other applications or programs executed by the system 100, such as an operating system and applications other than for image or video generation. Execution of the camera application, such as by the processor 104, may cause the system 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the system 100 does not include the memory 106. For example, the system 100 may be a circuit including the ISP 112, and the memory may be outside the system 100. The system 100 may be coupled to an external memory and configured to access the memory for writing output image frames for display or long-term storage. In some embodiments, the system 100 is a system-on-chip (SoC) that incorporates the ISP 112, the processor 104, the sensor hub 150, the memory 106, and/or components 116 into a single package.

In some embodiments, the processor 104 may include one or more processor cores 104A-N capable of executing instructions to control operation of the ISP 112. For example, the cores 104A-N may execute a camera application (or another application for generating images or video) stored in the memory 106 to activate or deactivate the ISP 112 for capturing image frames and/or to perform one or more operations associated with the HDR image reassembly engine 110.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AIPU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture system 100, such as through reinforcement training, supervised training, and/or unsupervised training. In some other embodiments, the system 100 may not include the processor 104, such as when all of the described functionality is configured in the ISP 112.

In some embodiments, the display 114 may include one or more displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

One or more cameras of the system 100 may include an HDR image selection engine. For example, the first camera 103 may include an HDR image selection engine 170. In some examples, the HDR image selection engine 170 may be included in or may be coupled to the first image sensor 101. Further, the second camera 105 may also include an HDR image selection engine corresponding to the HDR image selection engine 170.

During operation, the system 100 may perform an HDR image capture operation using one or more image sensors to generate exposures 160. To illustrate, in some examples, the system 100 may perform the HDR image capture using the first camera 103 or the second camera 105. For convenience, some examples associated with the HDR image capture operation may be described with reference to the first camera 103.

Performing the HDR image capture operation may include capturing multiple exposures 160. As referred to herein, “exposure” may indicate or may be associated with, for example, one or more of an exposure time, a pixel size, or a conversion gain. Further, the exposures 160 may be associated with different respective exposure times, different respective pixel sizes, different respective conversion gains, or a combination thereof. In some implementations, a pixel may be associated with (or “divided into”) multiple sub-pixels, which may be used to increase dynamic range for an image capture operation. In such examples, “pixel size” may indicate whether such sub-pixels are utilized in place of one pixel, may indicate a quantity of such sub-pixels (e.g., by indicating whether two, four, or eight sub-pixels are used in place of one pixel), or both.

To further illustrate, in some examples, the exposures 160 may include an exposure 160a associated with one or more of a first exposure time, a first pixel size, or a first conversion gain. The exposures 160 may further include an exposure 160b associated with one or more of a second exposure time that is different than the first exposure time, a second pixel size that is different than the first pixel size, or a second conversion gain that is different than the first conversion gain. Although some examples may be described with reference to two exposures 160, in other examples, the exposures 160 may include a different quantity of exposures (e.g., four exposures, eight exposures, or another quantity of exposures).

In some aspects of the disclosure, the HDR image selection engine 170 may select among pixel values of the exposures 160 and may provide the selected pixel values to the device 120 as image data 107. For example, the image data 107 may include, for each pixel value of the image data 107, the “best” pixel value from among the exposures 160. Accordingly, in some examples, the image data 107 may correspond to an image frame having pixel values selected from multiple different exposures 160.

In some examples, the HDR image selection engine 170 may select the pixel values from among the exposures 160 based on one or more criteria, such as by identifying, for each pixel value, that the particular exposure has a greatest signal-to-noise ratio (SNR) among unsaturated exposures of the exposures 160. As referred to herein, an “unsaturated” exposure may correspond to an exposure having a saturated level that is less than, or that is estimated or determined to be less than, a threshold saturation level. In some implementations, the threshold saturation level may be selected based on the particular application or system design.

To further illustrate, if the exposure 160b has a greater SNR than the exposure 160a for a pixel value, and if the exposures 160a, 160b are unsaturated, then the first camera 103 may select the pixel value from the exposure 160b and may include the pixel value in the image data 107. In another example, if the exposure 160b has a greater SNR than the exposure 160a for a pixel value, and if the exposure 160b is saturated and the exposure 160a is unsaturated, then the first camera 103 may select the pixel value from the exposure 160a and may include the pixel value in the image data 107.

After selecting a pixel value from among the exposures 160, the HDR image selection engine 170 may generate, for the pixel value, an indication 109 that the pixel value corresponds to a particular exposure of the exposures 160. Although the indication 109 may be described with reference to one pixel value of the image data 107 for illustration, it is noted that the indication 109 may indicate exposures for multiple pixels of the image data 107. In some examples, the indication 109 may indicate, for each pixel value of the image data 107, a corresponding exposure of the exposures 160 from which the pixel value is selected.

To illustrate, in an example of a two-exposure scheme, the pixel value may be selected from one of the two exposures, and the indication 109 may include or may correspond to a bit that indicates the exposure. In such examples, the bit may have one of a first value (e.g., a logic zero value or a logic one value) indicating that the pixel value is selected from exposure 160a or a second value (e.g., a logic one value or a logic zero value) indicating that the pixel value is selected from the exposure 160b. In other examples, more than two exposures may be used. For example, the exposures 160 may include four exposures, and the indication 109 may include two bits. In another example, the exposures 160 may include eight exposures, and the indication 109 may include three bits. Other examples are also within the scope of the disclosure.

The device 120 may receive the image data 107 and the indication 109. In some examples, the ISP 112 may receive the image data 107 and the indication 109. The ISP 112 may use the HDR image reassembly engine 110 to perform one or more operations associated with the image data 107 and the indication 109 to generate output image data 148. In some examples, performing the one or more operations may include selecting a gain value for a pixel value based on the indication 109. For example, the output image data 148 may correspond to a gain-adjusted version of the image data 107 having one or more pixel values that are adjusted using one or more gain values selected based on the indication 109. In some examples, the ISP 112 may provide the output image data 148 to the processor 104. In some other examples, the ISP 112 may perform one or more other operations using the output image data 148, such as by storing the output image data 148 to the memory 106, sending the output image data 148 to another device (e.g., via the components 116), or performing one or more other operations.

In some implementations, one or more of the first camera 103, the ISP 112, or the processor 104 may execute instructions to initiate, perform, or control one or more operations described herein. For example, execution of the instructions may cause the ISP 112 to begin or end capturing an image frame or a sequence of image frames using one or more cameras, such as the first camera 103, the second camera 105, or both. The image data 107 may include the image frame or sequence of image frames. Further, execution of the instructions may cause the ISP 112 to perform one or more operations using the HDR image reassembly engine 110 to generate the output image data 148. In addition, execution of the instructions may cause the ISP 112 to perform one or more operations based on the output image data 148. In some examples, the one or more operations may include storing the output image data 148 to the memory 106, presenting the output image data 148 via the display 114, transmitting the output image data 148 to another device via the components 116, providing the output image data 148 to the processor 104, performing one or more other operations, or a combination thereof.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. Additionally, other components, numbers of components, or combinations of components may be included in a device for performing aspects of the present disclosure. As such, the present disclosure is not limited to a specific device or configuration of components, including the system 100.

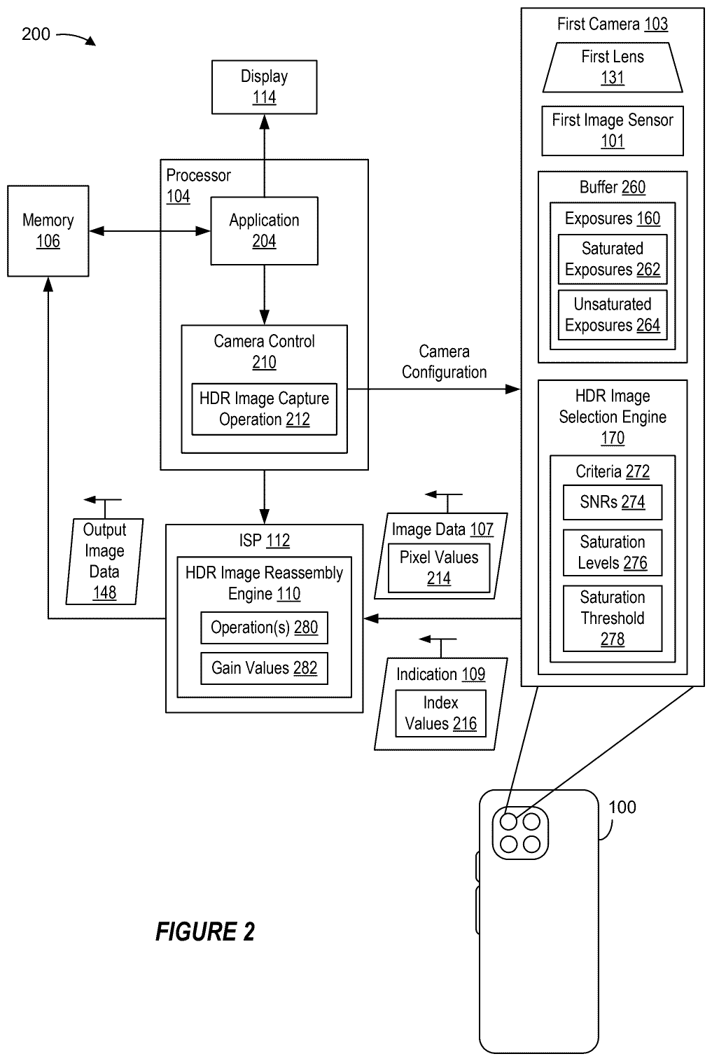

FIG. 2 is a block diagram illustrating an example of a system 200 that supports HDR image transfer. The system 100 may include or may correspond to the system 100 of FIG. 1. Further, although FIG. 2 may depict an implementation of the system 200 as a mobile device (such as a smart phone) for illustration, in some other examples, one or more features of the disclosure may be used with another type of device. To illustrate, in some other examples, the system 100 may be implemented as or included in a wearable device, such as a smart watch or a headset, in a standalone camera (such as a point-and-shoot camera or a surveillance camera), in a vehicle (such as a drone), or in another device, as illustrative examples.

Processor 104 of system 200 may communicate with ISP 112 through one or more buses or other structures, such as a bi-directional bus and/or separate control and data lines. The processor 104 may control the first camera 103 through camera control 210. The camera control 210 may include a camera driver executed by the processor 104 for configuring the first camera 103, such as to activate or deactivate image capture, configure exposure settings, and/or configure aperture size. In some examples, the camera control 210 may selectively activate and deactivate an HDR mode of operation of the first camera 103 (e.g., to select among HDR and non-HDR operation). The camera control 210 may be managed by an application 204 executed by the processor 104. The application 204 may enable a user to specify individual camera settings or select a profile with corresponding camera settings. Camera control 210 communicates with the first camera 103 to configure the first camera 103 in accordance with commands received from the application 204. The application 204 may be, for example, a photography application, a document scanning application, a messaging application, or another application that processes image data.

The camera configuration may include parameters that specify, for example, a frame rate, an image resolution, a readout duration, an exposure level, an aspect ratio, an aperture size, etc. The first camera 103 may apply the camera configuration and obtain image data 107 representing a scene using the camera configuration. In some embodiments, the camera configuration may be adjusted to obtain different representations of the scene. For example, the processor 104 may execute the application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some implementations in which the first camera 103 may be a variable aperture (VA) camera system, the processor 104 may execute the application 204 to instruct the first camera 103 to configure to a first aperture size and to obtain the first image data from the first camera 103. The processor 104 may also instruct the first camera 103 to configure to a second aperture size and to obtain the second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes (e.g., where f/2.0 corresponds to a larger aperture size than f/8.0).

During operation, the camera control 210 may initiate an HDR image capture operation 212. For example, the camera control 210 may provide, responsive to control from the application 204, an instruction to the first camera 103 to perform the HDR image capture operation 212. Based on the instruction, the first camera 103 may use the first image sensor 101 to capture the exposures 160.

In some implementations, the HDR image selection engine 170 may access the exposures 160. For example, in some implementations, the first camera 103 may include a buffer 260 couped to the first image sensor 101. After capturing the exposures 160, the first image sensor 101 may store the exposures 160 to the buffer 260, and the HDR image selection engine 170 may access the exposures 160 at the buffer 260.

In some examples, the HDR image selection engine 170 may select each pixel value 214 of the image data 107 from among the exposures 160 in accordance with one or more criteria 272. In some examples, the one or more criteria 272 may be based at least in part on signal-to-noise ratios (SNRs) 274 associated with pixel values of the exposures 160. In such examples, the HDR image selection engine 170 may select each pixel value 214 from the exposures 160 based on the SNR 274 associated with the pixel value 214. Further, in some examples, the one or more criteria 272 may be based at least in part on saturation levels 276 associated with pixel values of the exposures 160. In such examples, the HDR image selection engine 170 may select each pixel value 214 from the exposures 160 based on the saturation level 276 associated with the pixel value 214.

To further illustrate, in some examples, the HDR image selection engine 170 may identify (e.g., on a per-pixel basis) saturated exposures 262 of the exposures 160, unsaturated exposures 264 of the exposures 160, or both. In some examples, the HDR image selection engine 170 may compare pixels of the exposures 160 to a threshold saturation level, such as a saturation threshold 278. The saturated exposures 262 may meet the saturation threshold 278, and the unsaturated exposures 264 may fail to meet the saturation threshold 278. The HDR image selection engine 170 may select the pixel value 214 from among pixel values of the unsaturated exposures 264 based on identifying that an SNR 274 associated with the pixel value 214 exceeds SNRs 274 associated with corresponding pixel values of the other unsaturated exposures 264. In such examples, the one or more criteria 272 may include a determination that, among at least a subset of the exposures 160 (e.g., the unsaturated exposures 264) having saturation levels 276 that fail to meet the saturation threshold 278, the SNR 274 associated with a particular exposure of the subset exceeds other SNRs 274 associated with other exposures of the subset.

Based on selection of the pixel values 214 from among the exposures 160 (or from among the unsaturated exposures 264), the HDR image selection engine 170 may output the pixel values 214 to one or more other devices or components. For example, the HDR image selection engine 170 may provide the pixel values 214 to the ISP 112. The particular pixel values 214 may be included in, or may correspond to, the image data 107.

The HDR image selection engine 170 may also provide the indication 109 to the ISP 112. In some examples, the indication 109 may include or may indicate index values 216 associated with the pixel values 214. For example, each pixel value 214 of the image data 107 may have a respective index value 216, and each index value 216 may specify one of the exposures 160. In some implementations, the indication 109 may include a bitmap, a mapping table, or another type of data structure that is configured to indicate the index values 216.

The ISP 112 may receive the image data 107 and the indication 109. The ISP 112 may perform one or more operations 280 in accordance with the image data 107 and the indication 109. To illustrate, in some examples, performing the one or more operations 280 may include identifying, based on the indication 109, an exposure of the exposures 160 for each pixel value 214 of the pixel values 214. As an illustrative example, in a two-exposure example of the HDR image capture operation 212, an index value 216 of “0” may indicate that the exposure 214 is the initial exposure of the exposures 160 (e.g., exposure “one of two”), and an index value 216 of “1” may indicate that the exposure 214 is the latter exposure of the exposures 160 (e.g., exposure “two of two”). Further, in some examples, the initial exposure may be associated with one or more of a first exposure time, a first pixel size, or a first conversion gain, and the latter exposure may be associated with a second exposure time that is different than the first exposure time, a second pixel size that is different than the first pixel size, or a second conversion gain that is different than the first conversion gain. Other examples are also within the scope of the disclosure.

In some examples, performing the one or more operations 280 may include recreating an HDR pixel value using the particular index value. Further, in some examples, the ISP 112 may scale the image data 107. Scaling the image data 107 may also be referred to herein as applying conversion gain factors to the image data 107. To illustrate, some examples, performing the one or more operations 280 may include selecting a particular gain value (including a conversion gain factor) in accordance with the indication 109 (e.g., by selecting the gain value from among gain values 282) and may further include scaling a pixel value 214 in accordance with the gain value. In some examples, the ISP 112 may store a mapping table, such as a lookup table (LUT), of the index values 216 to the gain values 282. In another example, the HDR image reassembly engine 110 may include a multiplexer (MUX). The MUX may include a data input configured to receive the gain values 282. The MUX may further include a control input (e.g., an enable input) configured to receive each index value 216. Based on each index value 216 of the indication 109, the MUX may output a particular gain value of the gain values 282. In some examples, the gain values 282 may be read or accessed at a start-up or initialization stage, such as by reading the gain values 282 from a non-volatile memory (e.g., the memory 106 or another memory).

In some additional examples, performing the one or more operations 280 may include applying one or more effects, such as a Bokeh effect, a lighting effect, a color casting effect, one or more other effects, or a combination thereof. Further, it is noted that, although the one or more operations 280 may be described with reference to the ISP 112, in other examples, at least some of the one or more operations 280 may be performed by the processor 104.

The ISP 112 (or the processor 104) may output one or more image frames in accordance with the one or more operations 280. For example, the one or more image frames may include or may correspond to the output image data 148. In some examples, the output image data 148 may be stored to the memory 106, provided to the processor 104, presented to a user (such as via the display 114), transmitted to one or more other devices, or a combination thereof.

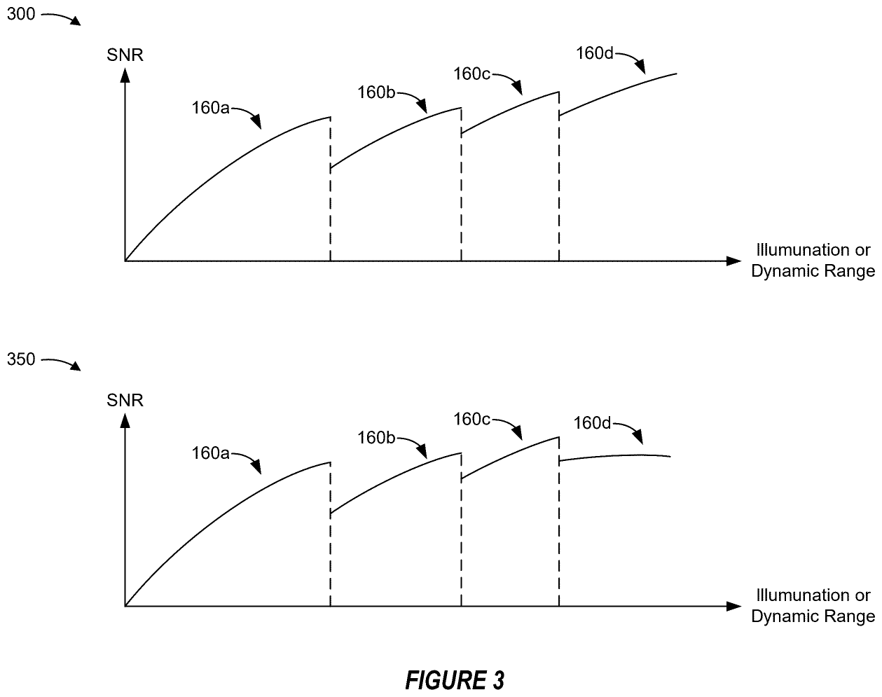

FIG. 3 is a diagram illustrating examples of graphs 300 and 350 that may be associated with HDR image transfer. Each of the graphs 300 and 350 may include an abscissa indicating illumination or dynamic range (e.g., for a particular pixel) and may further include an ordinate indicating SNR (e.g., for the particular pixel). The graphs 300 and 350 may be associated with the exposures 160, which may include exposures 160a, 160b, 160c, and 160d. In some other examples, more than four, or fewer than four, exposures 160 may be used.

In the example of the graph 300, the exposures 160a-d may be unsaturated. For example, in the graph 300, slopes of the curves corresponding to the exposures 160a-d may satisfy a threshold, such as the saturation threshold 278. In such examples, the exposure 160d may be selected for a pixel value (because the exposure 160d may be associated with a greater SNR as compared to the exposures 160a-c) and may be provided to the ISP 112 in connection with the image data 107.

In the example of the graph 350, the exposures 160a-c may be unsaturated, and the exposure 160d may be saturated. For example, in the graph 350, slopes of the curves corresponding to the exposures 160a-c may satisfy a threshold, such as the saturation threshold 278, and the slope of the curve corresponding to exposure 160d may fail to satisfy the threshold. In such examples, the exposure 160c may be selected for a pixel value (because the exposure 160c may be associated with a greater SNR as compared to the exposures 160a-b) and may be provided to the ISP 112 in connection with the image data 107.

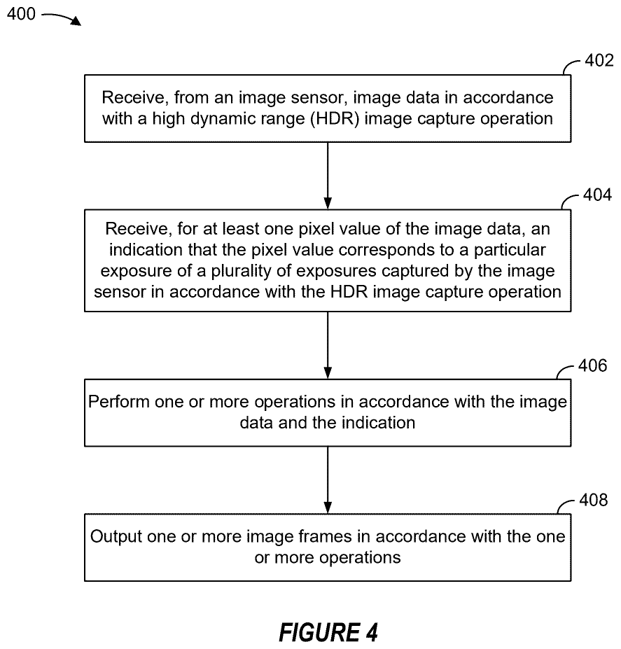

FIG. 4 is a flow chart illustrating an example of a method 400 that supports HDR image transfer. In some examples, the method 400 may be performed by one or more devices described herein, such as by one or more of the system 100, the device 120, the ISP 112, the system 200, one or more other devices, or a combination thereof.

The method 400 includes receiving, from an image sensor, image data in accordance with a high dynamic range (HDR) image capture operation, at 402. To illustrate, in some examples, the device 120 may receive the image data 107 from the first image sensor 101, such as in connection with the image capture operation 212.

The method 400 further includes receiving, for at least one pixel value of the image data, an indication that the pixel value corresponds to a particular exposure of a plurality of exposures captured by the image sensor in accordance with the HDR image capture operation, at 404. For example, the device 120 may receive the indication 109. In some examples, the indication 109 may indicate that a pixel value of the pixel values 214 corresponds to a particular exposure of the exposures 160, such as the exposure 160a, the exposure 160b, the exposure 160c, or the exposure 160d.

The method 400 further includes performing one or more operations in accordance with the image data and the indication, at 406. For example, the device 120 may perform the one or more operations 280 in accordance with the image data 107 and the indication 109. In some examples, performing the one or more operations 280 may include scaling the image data 107 (which may also be referred to herein as applying conversion gain factors to the image data 107), such as by applying the gain values 282 to the image data 107 based on the indication 109.

The method 400 further includes outputting one or more image frames in accordance with the one or more operations, at 408. For example, the one or more image frames may include or may correspond to the output image data 148. To further illustrate, in some examples, outputting the one or more image frames may include storing the output image data 148 to the memory 106, presenting the output image data 148 via the display 114, transmitting the output image data 148 to another device via the components 116, providing the output image data 148 to the processor 104, performing one or more other operations, or a combination thereof.

In some aspects of the disclosure, a processing system may initiate, perform, or control one or more operations described herein. In some examples, the processing system may include one or more processors (such as one or more of the ISP 112 or the processor 104) and one or more memories (such as the memory 106) coupled to the one or more processors. In some examples, the processing system may perform one or more operations of the method 400 of FIG. 4. In some examples, a computer-readable medium (such as the memory 106) may store instructions (such as the instructions 108) executable by the processing system to initiate, perform, or control one or more operations described herein, such as one or more operations of the method 400 of FIG. 4.

One or more features described herein may improve performance of a device that captures images or that receives captured images. For example, by selecting pixel values 214 from among the different exposures 160 “in camera” (e.g., at first camera 103) and prior to sending image data to the ISP 112 (or other component of the device 120), an amount of data transferred over a bus between the camera and the ISP 112 or other component may be reduced as compared to other techniques, such as techniques that involve transferring all exposures of the bus. As a non-limiting example, in some implementations, a pixel value 214 may include (or may be represented by) eight bits, and the HDR image capture operation 212 may include capturing four exposures 160. In such examples, some techniques may involve transferring thirty-two bits for each pixel of image data (8*4=32). In some aspects of the disclosure, a pixel value 214 may be selected from a particular exposure of the four exposures 160, and two bits may be used to indicate the particular exposure, resulting in a transfer of ten bits (8+2=10) for each pixel. Accordingly, a quantity of bits transferred over a bus or other connection may be reduced, reducing a traffic load associated with the bus or other connection. Further, the traffic load may be reduced without use of a compression scheme that may introduce data loss. Accordingly, traffic load may be reduced while increasing (or maintaining) data quality.

To further illustrate, in some examples, one or more features described herein may be used in accordance with one or more of the following illustrative clauses.

Clause 1: A method of operation of a processing system, the method comprising: receiving, from an image sensor, image data in accordance with a high dynamic range (HDR) image capture operation; receiving, for at least one pixel value of the image data, an indication that the pixel value corresponds to a particular exposure of a plurality of exposures captured by the image sensor in accordance with the HDR image capture operation; performing one or more operations in accordance with the image data and the indication; and outputting one or more image frames in accordance with the one or more operations.

Clause 2: The method of clause 1, wherein performing the one or more operations includes: selecting a particular gain value in accordance with the indication; and scaling the pixel value in accordance with the particular gain value.

Clause 3: The method of any of clauses 1-2, wherein the particular exposure is selected from among the plurality of exposures by the image sensor in accordance with one or more criteria.

Clause 4: The method of any of clauses 1-3, wherein the one or more criteria are based at least in part on a signal-to-noise ratio (SNR) associated with the particular exposure.

Clause 5: The method of any of clauses 1-4, wherein the one or more criteria are based at least in part on a saturation level associated with the particular exposure.

Clause 6: The method of any of clauses 1-5, wherein the one or more criteria include a determination that, among at least a subset of the plurality of exposures having saturation levels that fail to meet a threshold saturation level, the SNR associated with the particular exposure exceeds other SNRs associated with other exposures of the subset.

Clause 7: The method of any of clauses 1-6, wherein the particular exposure is associated with one or more of a first exposure time, a first pixel size, or a first conversion gain, and wherein at least one other exposure of the plurality of exposures is associated with one or more of a second exposure time that is different than the first exposure time, a second pixel size that is different than the first pixel size, or a second conversion gain that is different than the first conversion gain.

Clause 8: An apparatus comprising: a processing system including one or more processors and one or more memories coupled to the one or more processors, the processing system configured to: receive, from an image sensor, image data in accordance with a high dynamic range (HDR) image capture operation; receive, for at least one pixel value of the image data, an indication that the pixel value corresponds to a particular exposure of a plurality of exposures captured by the image sensor in accordance with the HDR image capture operation; perform one or more operations in accordance with the image data and the indication; and output one or more image frames in accordance with the one or more operations.

Clause 9: The apparatus of clause 8, wherein, in connection with the one or more operations, the processing system is further configured to: select a particular gain value in accordance with the indication; and scale the pixel value in accordance with the particular gain value.

Clause 10: The apparatus of any of clauses 8-9, wherein the processing system is further configured to select the particular exposure from among the plurality of exposures by the image sensor in accordance with one or more criteria.

Clause 11: The apparatus of any of clauses 8-10, wherein the one or more criteria are based at least in part on a signal-to-noise ratio (SNR) associated with the particular exposure.

Clause 12: The apparatus of any of clauses 8-11, wherein the one or more criteria are based at least in part on a saturation level associated with the particular exposure.

Clause 13: The apparatus of any of clauses 8-12, wherein the one or more criteria include a determination that, among at least a subset of the plurality of exposures having saturation levels that fail to meet a threshold saturation level, the SNR associated with the particular exposure exceeds other SNRs associated with other exposures of the subset.

Clause 14: The apparatus of any of clauses 8-13, wherein the particular exposure is associated with one or more of a first exposure time, a first pixel size, or a first conversion gain, and wherein at least one other exposure of the plurality of exposures is associated with one or more of a second exposure time that is different than the first exposure time, a second pixel size that is different than the first pixel size, or a second conversion gain that is different than the first conversion gain.

Clause 15: A non-transitory computer-readable medium storing instructions executable by a processing system to initiate, perform, or control operations, the operations comprising: receiving, from an image sensor, image data in accordance with a high dynamic range (HDR) image capture operation; receiving, for at least one pixel value of the image data, an indication that the pixel value corresponds to a particular exposure of a plurality of exposures captured by the image sensor in accordance with the HDR image capture operation; performing one or more operations in accordance with the image data and the indication; and outputting one or more image frames in accordance with the one or more operations.

Clause 16: The non-transitory computer-readable medium of clause 15, wherein performing the one or more operations includes: selecting a particular gain value in accordance with the indication; and scaling the pixel value in accordance with the particular gain value.

Clause 17: The non-transitory computer-readable medium of any of clauses 15-16, wherein the particular exposure is selected from among the plurality of exposures by the image sensor in accordance with one or more criteria.

Clause 18: The non-transitory computer-readable medium of any of clauses 15-17, wherein the one or more criteria are based at least in part on a signal-to-noise ratio (SNR) associated with the particular exposure.

Clause 19: The non-transitory computer-readable medium of any of clauses 15-18, wherein the one or more criteria are based at least in part on a saturation level associated with the particular exposure.

Clause 20: The non-transitory computer-readable medium of any of clauses 15-19, wherein the one or more criteria include a determination that, among at least a subset of the plurality of exposures having saturation levels that fail to meet a threshold saturation level, the SNR associated with the particular exposure exceeds other SNRs associated with other exposures of the subset.

In the figures, a single block may be described as performing a function or functions: The function or functions performed by that block may be performed in a single component or across multiple components, and/or may be performed using hardware, software, or a combination of hardware and software. To illustrate, various illustrative components, blocks, modules, circuits, and operations may be described in terms of functionality. Whether such functionality is implemented as hardware or software may depend upon the particular application and the overall system design. Skilled artisans may implement the described functionality in varying ways for each particular application, but such implementation decisions should not be interpreted as causing a departure from the scope of the disclosure. Also, the example devices may include components other than those shown, including well-known components such as a processor, memory, and the like.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (such as application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc, where disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 5, 5, or 50 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of operation of a processing system, the method comprising:
receiving, from an image sensor, image data in accordance with a high dynamic range (HDR) image capture operation;
receiving, for at least one pixel value of the image data, an indication that the pixel value corresponds to a particular exposure of a plurality of exposures captured by the image sensor in accordance with the HDR image capture operation;
performing one or more operations in accordance with the image data and the indication; and
outputting one or more image frames in accordance with the one or more operations.

2. The method of claim 1, wherein performing the one or more operations includes:
selecting a particular gain value in accordance with the indication; and
scaling the pixel value in accordance with the particular gain value.

3. The method of claim 1, wherein the particular exposure is selected from among the plurality of exposures by the image sensor in accordance with one or more criteria.

4. The method of claim 3, wherein the one or more criteria are based at least in part on a signal-to-noise ratio (SNR) associated with the particular exposure.

5. The method of claim 3, wherein the one or more criteria are based at least in part on a saturation level associated with the particular exposure.

6. The method of claim 3, wherein the one or more criteria include a determination that, among at least a subset of the plurality of exposures having saturation levels that fail to meet a threshold saturation level, the SNR associated with the particular exposure exceeds other SNRs associated with other exposures of the subset.

7. The method of claim 1, wherein the particular exposure is associated with one or more of a first exposure time, a first pixel size, or a first conversion gain, and wherein at least one other exposure of the plurality of exposures is associated with one or more of a second exposure time that is different than the first exposure time, a second pixel size that is different than the first pixel size, or a second conversion gain that is different than the first conversion gain.

8. An apparatus comprising:
a processing system including one or more processors and one or more memories coupled to the one or more processors, the processing system configured to:
receive, from an image sensor, image data in accordance with a high dynamic range (HDR) image capture operation;
receive, for at least one pixel value of the image data, an indication that the pixel value corresponds to a particular exposure of a plurality of exposures captured by the image sensor in accordance with the HDR image capture operation;
perform one or more operations in accordance with the image data and the indication; and
output one or more image frames in accordance with the one or more operations.

9. The apparatus of claim 8, wherein, in connection with the one or more operations, the processing system is further configured to:
select a particular gain value in accordance with the indication; and
scale the pixel value in accordance with the particular gain value.

10. The apparatus of claim 8, wherein the processing system is further configured to select the particular exposure from among the plurality of exposures by the image sensor in accordance with one or more criteria.

11. The apparatus of claim 10, wherein the one or more criteria are based at least in part on a signal-to-noise ratio (SNR) associated with the particular exposure.

12. The apparatus of claim 10, wherein the one or more criteria are based at least in part on a saturation level associated with the particular exposure.

13. The apparatus of claim 10, wherein the one or more criteria include a determination that, among at least a subset of the plurality of exposures having saturation levels that fail to meet a threshold saturation level, the SNR associated with the particular exposure exceeds other SNRs associated with other exposures of the subset.

14. The apparatus of claim 8, wherein the particular exposure is associated with one or more of a first exposure time, a first pixel size, or a first conversion gain, and wherein at least one other exposure of the plurality of exposures is associated with one or more of a second exposure time that is different than the first exposure time, a second pixel size that is different than the first pixel size, or a second conversion gain that is different than the first conversion gain.

15. A non-transitory computer-readable medium storing instructions executable by a processing system to initiate, perform, or control operations, the operations comprising:
receiving, from an image sensor, image data in accordance with a high dynamic range (HDR) image capture operation;
receiving, for at least one pixel value of the image data, an indication that the pixel value corresponds to a particular exposure of a plurality of exposures captured by the image sensor in accordance with the HDR image capture operation;
performing one or more operations in accordance with the image data and the indication; and
outputting one or more image frames in accordance with the one or more operations.

16. The non-transitory computer-readable medium of claim 15, wherein performing the one or more operations includes:
selecting a particular gain value in accordance with the indication; and
scaling the pixel value in accordance with the particular gain value.

17. The non-transitory computer-readable medium of claim 15, wherein the particular exposure is selected from among the plurality of exposures by the image sensor in accordance with one or more criteria.

18. The non-transitory computer-readable medium of claim 17, wherein the one or more criteria are based at least in part on a signal-to-noise ratio (SNR) associated with the particular exposure.

19. The non-transitory computer-readable medium of claim 17, wherein the one or more criteria are based at least in part on a saturation level associated with the particular exposure.

20. The non-transitory computer-readable medium of claim 17, wherein the one or more criteria include a determination that, among at least a subset of the plurality of exposures having saturation levels that fail to meet a threshold saturation level, the SNR associated with the particular exposure exceeds other SNRs associated with other exposures of the subset.
